(19) United States
(12) Patent Application Publication
(10) Pub. No.: US 2024/0420601 A1
(43) Pub. Date: Dec. 19, 2024

(54) FRAMES, TOOL, AND METHOD FOR ALIGNING AND SPACING SYMBOLS TO BE INSTALLED ON A SURFACE

(71) Applicant: MON ADRESSE CIVIQUE INC, SHEFFORD (CA)

(72) Inventor: Patrick Fontanals, GRANBY (CA)

(73) Assignee: MON ADRESSE CIVIQUE INC, SHEFFORD (CA)

(21) Appl. No.: 18/738,110

(22) Filed: Jun. 10, 2024

Related U.S. Application Data
(60) Provisional application No. 63/508,053, filed on Jun. 14, 2023.

(51) Int. Cl. G09F 7/10; G09F 7/18

(52) U.S. Cl. CPC G09F 7/10; G09F 7/18

(57) ABSTRACT

The present disclosure relates to a frame, a tool and method for positioning a plurality of symbols to be installed on a surface. The tool and method rely on a plurality of frames where each frame defines an aperture corresponding to one of the symbols to be positioned and a supporting structure for receiving the frames. Each frame provides a border around the aperture and defines two opposite spacing guides. At least one spacing guide of each frame comprises at least one of: a bump and/or a recess. The combination of the spacing guides of contiguous frames creates a predefined spacing between the symbols received therein.

### TECHNICAL FIELD

The present disclosure relates to the field of installation of symbols, and more particularly to frames for aligning and spacing symbols for installation on a surface and a method for installing symbols on a surface.

### BACKGROUND

Installing symbols on a building or on a wall, such as signaling or civic addresses, requires patience and manual skills. The distance between consecutive symbols depends on the shape, size and combination of symbols being installed. The methodology for aligning and spacing consecutive symbols typically falls into of the following in two approaches: visually approximating spacing between consecutive symbols or preparing and printing a custom template to be affixed to the building or wall. Preparing and printing a custom template is time consuming, creates unnecessary waste as the custom template is once and discarded after use, and complicates the installation of symbols on buildings and/or walls. Furthermore, certain shapes of symbols are more difficult to properly adjust space therebetween, which renders the visual approximation very difficult. Properly spaced symbols add to a residence's curb appeal and convey an attention to details.

There is therefore a need for frames, a tool and a method for properly and reliably spacing symbols for installation, and to a method for aligning and spacing symbols for installation.

### SUMMARY

According to a first aspect, the present disclosure relates to a frame for positioning a symbol to be installed on a surface. The frame defines an aperture corresponding to the symbol to be positioned. The frame comprises a border around said aperture, the border defining two opposite spacing guides. At least one spacing guide comprises at least one of: a bump and a recess. When the spacing guide of the frame is placed contiguously to a spacing guide of another frame on the surface, the combination of the spacing guide and the contiguous spacing guide creates a predefined spacing between the symbols received in the frame and the contiguous frame.

According to a second aspect, the present disclosure relates to a method for positioning a plurality of symbols to be installed on a surface. The method comprises selecting at least two frames, where each frame defines an aperture corresponding to one of the symbols to be installed on the surface, each frame provides a border around said aperture, the border defining a securing guide and two opposite spacing guides wherein each spacing guide is adjacent an opposite end of the securing guide. At least one spacing guide of each frame comprises at least one of: a bump and a recess. The method continues with inserting the securing guides of at least two frames in a supporting structure and ensuring order and contact of the spacing guides of sequential frames. The combination of spacing guides of contiguous frames creates a predefined spacing between the symbols received therein. The method further includes temporarily affixing the supporting structure on a wall where the symbols are to be installed, positioning the symbols to be installed through the apertures of the frames.

According to another aspect, the present disclosure relates to another method for positioning symbols to be installed on a surface. The method comprises selecting at least two frames, each frame defining an aperture corresponding to one of the symbols to be installed, each frame providing a border around said aperture, said border defining a securing guide and two opposite spacing guides wherein each spacing guide is adjacent an opposite of the securing guide. At least one spacing guide of each frame comprises at least one of a bump or a recess. The method further includes inserting the securing guides of at least two consecutive frames in a supporting structure and ensuring order of the at least two frames and contact of the spacing guides of sequential frames. The combination of spacing guides of contiguous frames creates a predefined spacing between the symbols when installed. The method also includes temporarily affixing the supporting structure on the surface where the symbols are to be installed and marking on the surface position of the symbols for installation through the apertures of the frames.

### BRIEF DESCRIPTION OF THE DRAWINGS

Embodiments of the disclosure will be described by way of example only with reference to the accompanying drawings, in which:

FIGS. 1A-1J illustrate exemplary front views of frames for symbols 0-9 respectively;

FIGS. 2A-2c illustrate front views of examples of supporting structure;

FIG. 3A-3D depict four examples of the supporting structure with a combination of symbols inserted therein and a predefined spacing; and

FIG. 4 is a flowchart of a method for installing symbols using the present tool.

### DETAILED DESCRIPTION

The foregoing and other features will become more apparent upon reading of the following non-restrictive description of illustrative embodiments thereof, given by way of example only with reference to the accompanying drawings. Like symbols represent like features on the various drawings.

Various aspects of the present disclosure generally resolve the issues encountered when positioning and/or installing combinations of symbols forming a symbol on a surface.

Throughout the present specification, the word “symbol” is used to refer to any separate or detached physical symbol that is to be installed on a building, house, apartment, suite, condominium, room, or any type of object or surface, either interior or exterior. Symbols include letters, numbers, and any type of character, logo, sign or any other visual identifier.

Symbols come in all sorts of shapes and sizes. This large variety of options renders customization easily possible and affordable. Selecting the proper shape and size of symbols is important to ensure visual balance and attractiveness. But the installation of the selected symbols on a surface is a challenge as each shape and size of symbols requires a different positioning to ensure proper spacing between consecutive symbols. The main difficulty lies in the fact that the width of each symbol varies height wise.

To overcome the present problems with the positioning and installation of combinations of symbols, the present tool and method rely on frames, where each frame defines a positioning frame for one symbol, and a supporting structure adapted for receiving combinations of multiple frames. Contiguous frames create a predefined spacing between the symbols received therein.

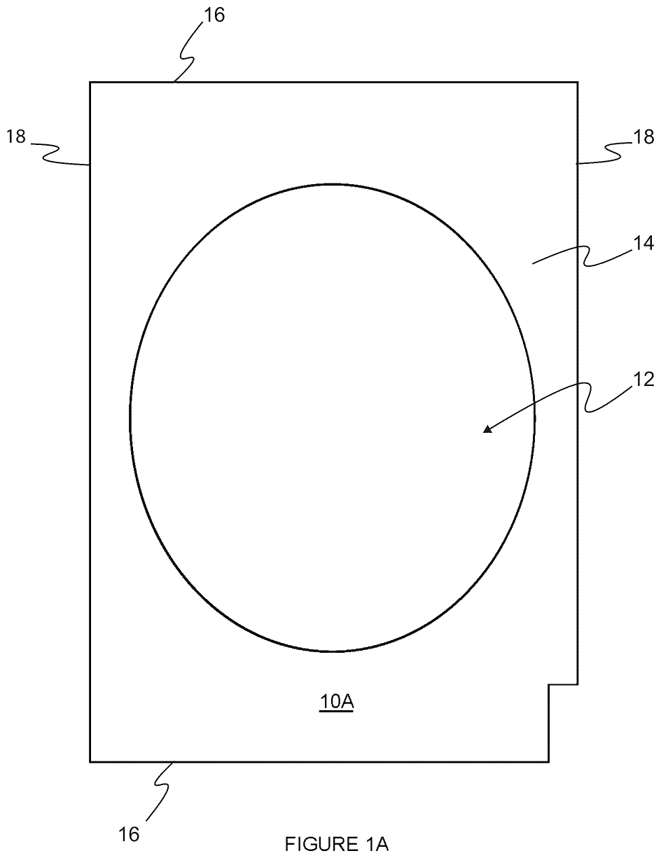

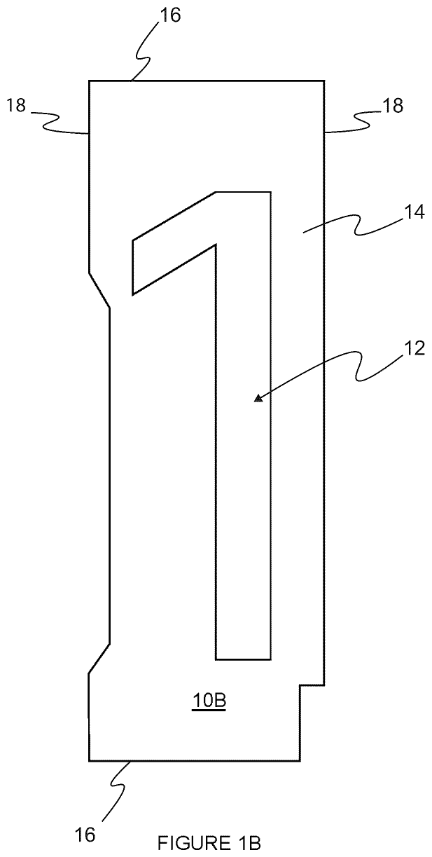

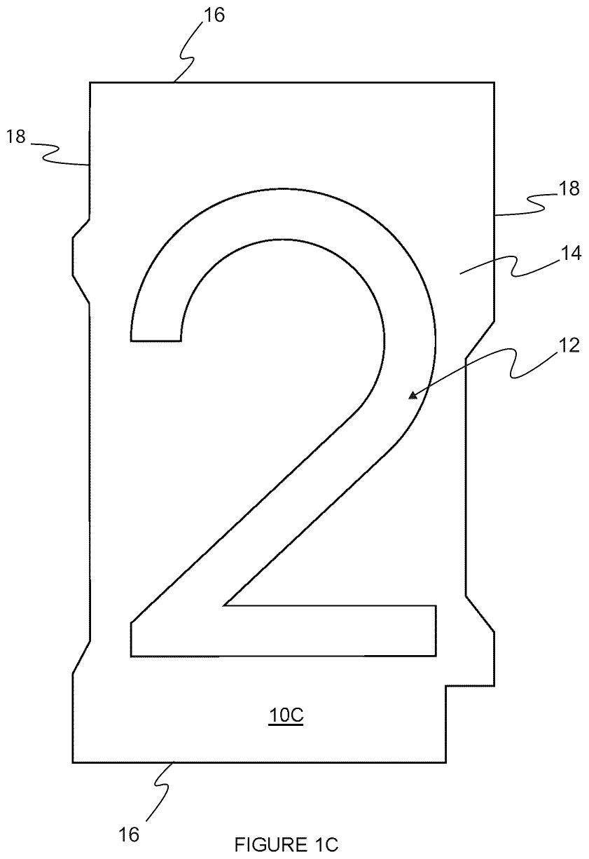

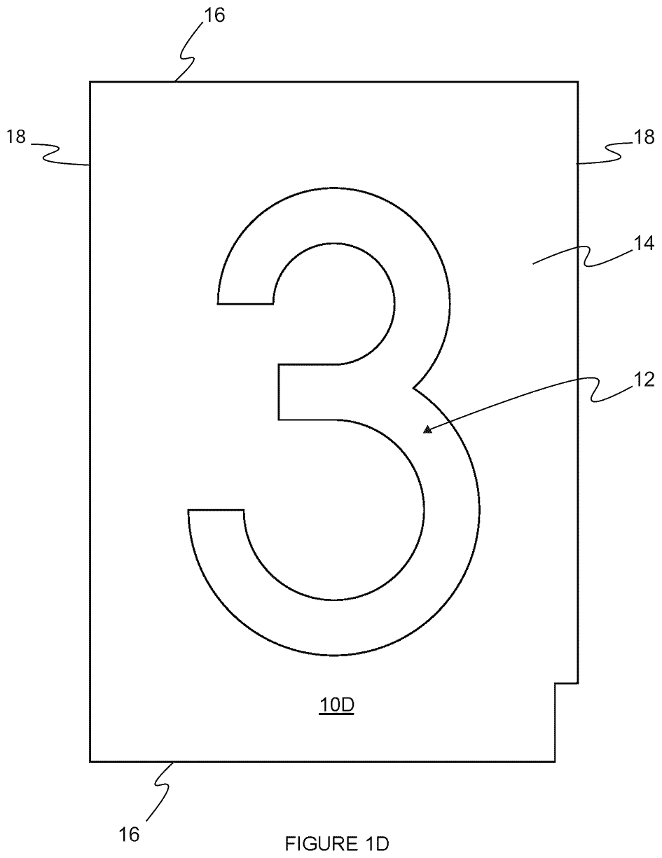

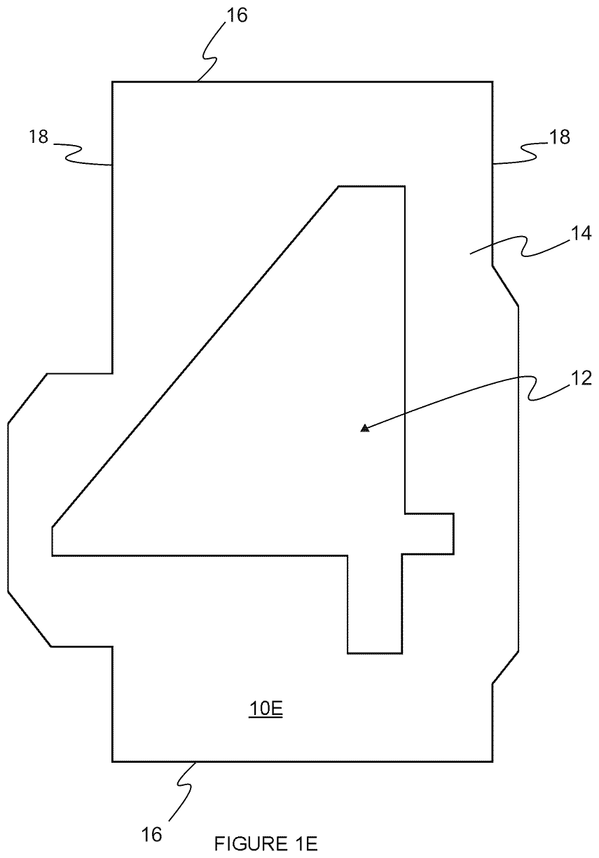

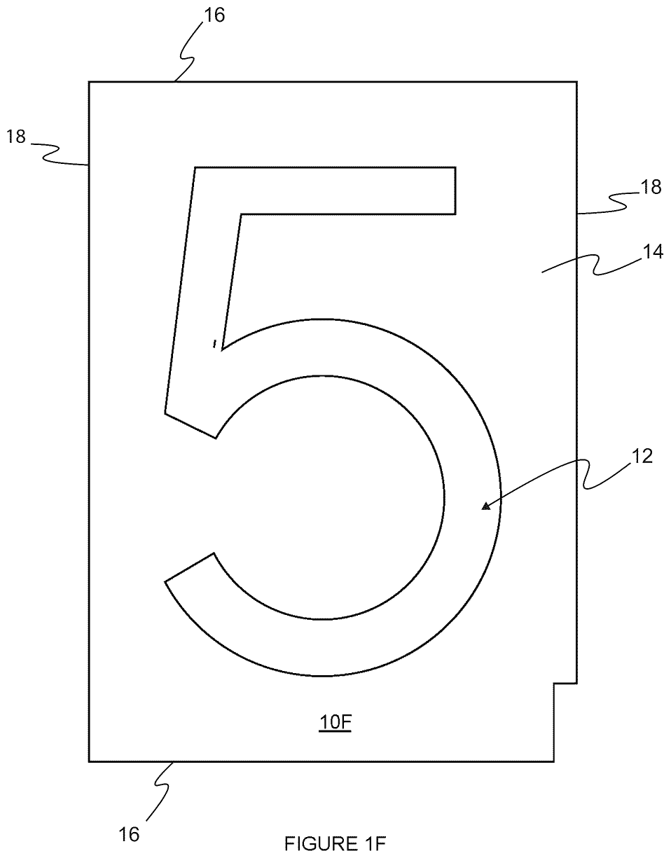

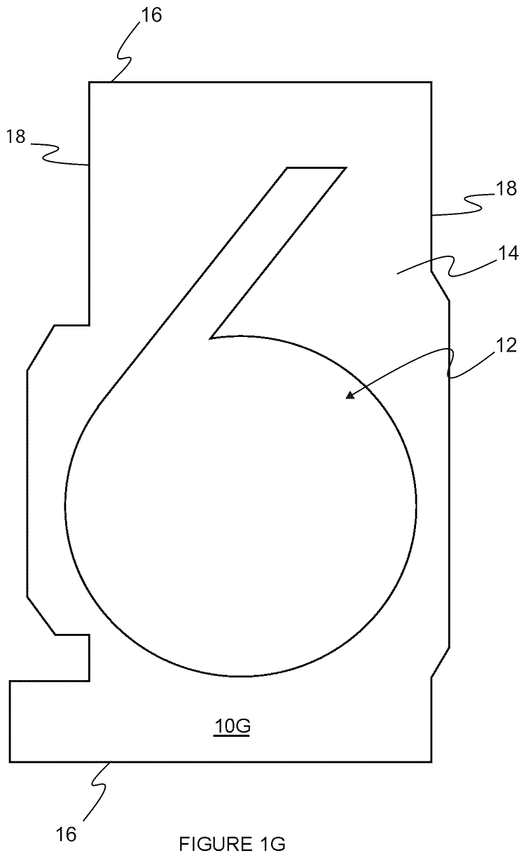

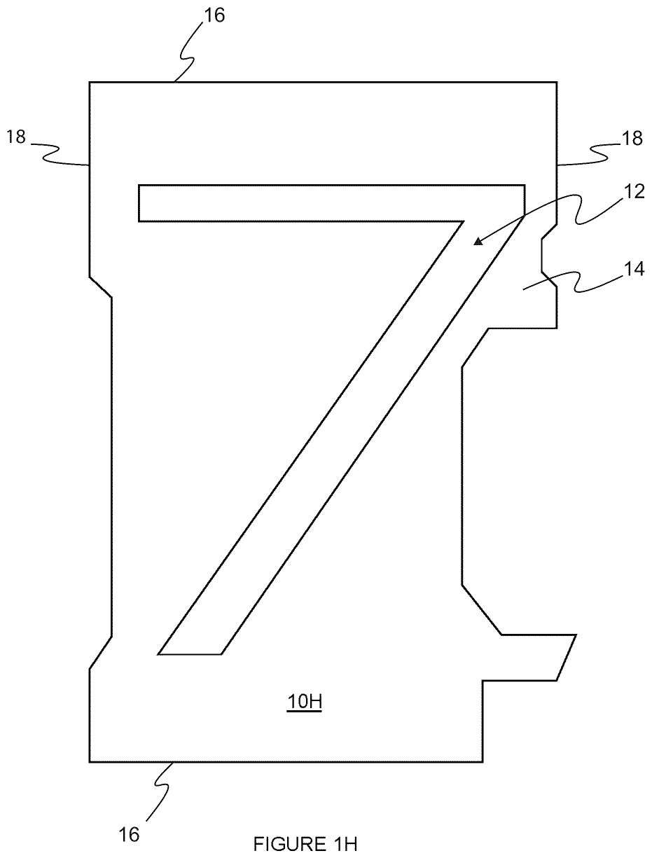

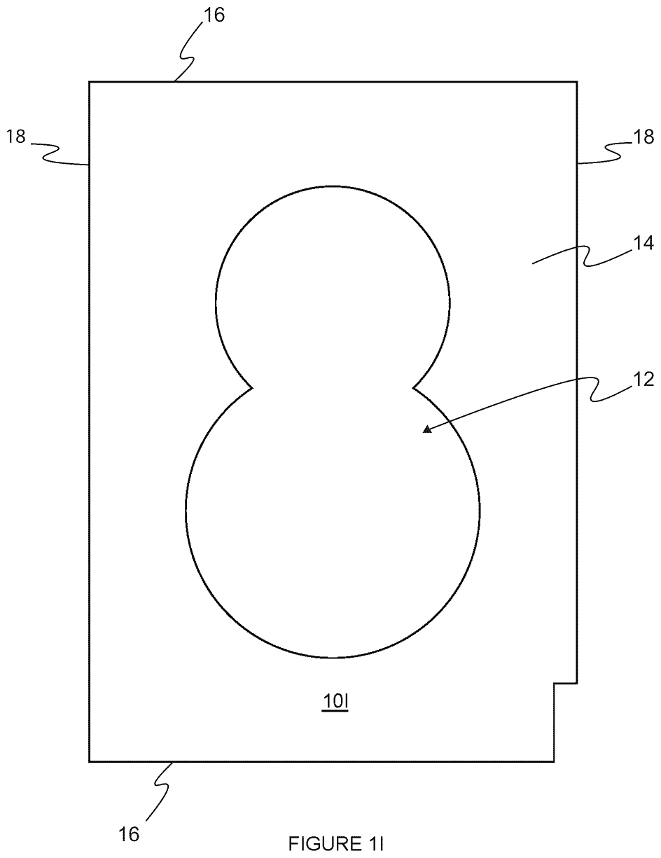

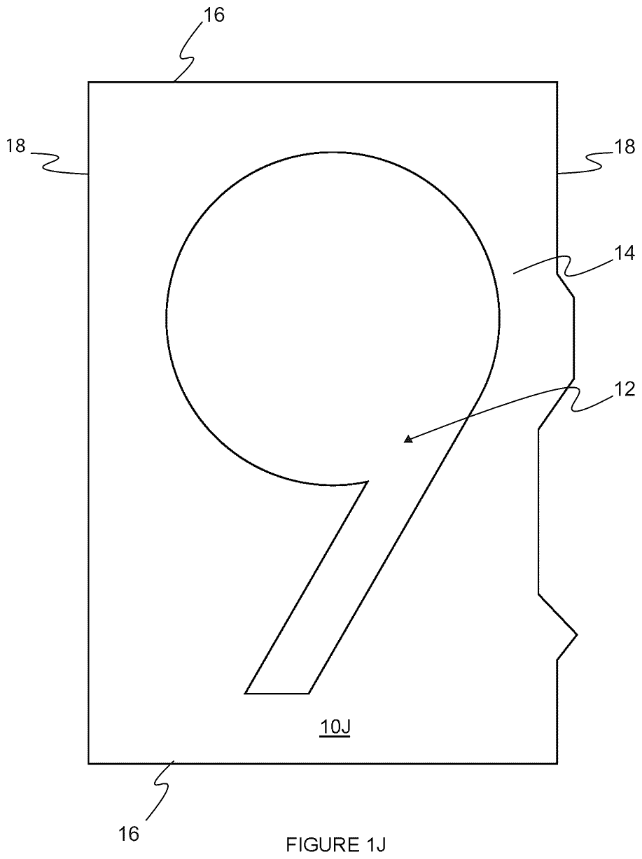

Referring now concurrently to FIGS. 1A-1J, each one of FIGS. 1A-1J illustrate an exemplary front view of a frame 10A-10J respectively. Each frame 10A-10J defines an aperture 12. The aperture 12 of frame 10A is adapted for receiving a “0” symbol, the aperture 12 of frame 10B is adapted for receiving a “1” symbol, the aperture 12 of frame 10C is adapted for receiving a “2” symbol, the aperture 12 of frame 10D is adapted for receiving a “3” symbol, the aperture 12 of frame 10E is adapted for receiving a “4” symbol, the aperture 12 of frame 10F is adapted for receiving a “5” symbol, the aperture 12 of frame 10G is adapted for receiving a “6” symbol, the aperture 12 of frame 10H is adapted for receiving a “7” symbol, the aperture 12 of frame 10I is adapted for receiving a “8” symbol, and the aperture 12 of frame 10J is adapted for receiving a “9” symbol. Although FIGS. 1A-1J depict numerals, the present tool and method are not limited to such symbols and could be used for letters, logos, characters or any other type of sign or visual identifier.

For clarity purposes, the foregoing description will refer to the frame, in singular and plural form, as reference 10. Each frame 10 defines an aperture 12 corresponding to one of the symbols to be positioned. Each frame 10 provides a border 14 around said aperture 12, the border 14 defining two opposite spacing guides 18. At least one spacing guide 18 of each frame 10 comprises at least one of: a bump and a recess. When the frames 12 are placed contiguously on the surface where the symbols are to be positioned, the combination of spacing guides of contiguous frames creates a predefined spacing between the symbols received therein.

In a particular embodiment, the border 14 may further define one or two securing guides 16. Each spacing guide 18 is adjacent an opposite end of the securing guide 16. More particularly, the spacing guides 18 vary in size around the aperture 12 Although the frames 10 are depicted with two parallel and opposite securing guides 16, one securing guide at the top of the frames 10 and another securing guide 16 at the bottom of the frames 10, the present frames and tool are not limited to such a configuration. In the FIGS. 1A-1J, the spacing guides 18 are adjacent opposite ends of the securing guides 16.

In all embodiments, the frames 10 share one particularity: at least one spacing guide 18 of the frame 10 includes at least one of a bump and/or a recess. The frame 10A shown on FIG. 1A is adapted for receiving a symbol which is shaped as a ‘0’ and includes a left spacing guide 18 which does not include a bump or a recess, while the right spacing guide 18 includes a recess near the bottom hand right corner of the frame 10A. The frame 10B shown on FIG. 1B is adapted for receiving a symbol shaped as a ‘1’ and includes a left spacing guide 18 which comprises a long substantially median recess and a right spacing guide which comprises a recess near the bottom hand right corner of the frame 10B. The frame 10C shown on FIG. 1C is adapted for receiving a symbol shaped as a ‘2’ and includes a left spacing guide comprising two bumps, and a right spacing guide with two recesses, one in a substantially median portion of the spacing guide and another deeper recess near a bottom of the spacing guide 18. The frame 10D shown on FIG. 1D is adapted for receiving a symbol which is shaped as a '3 and includes a left spacing guide 18 which does not include a bump or a recess, while the right spacing guide 18 includes a recess near the bottom hand right corner of the frame 10D. Although the description of the spacing guides 18 of the frames 10A and 1-D shown respectively on FIGS. 1A and 1D, the border 14 defined between the aperture 12 and the spacing guides 18 are not identical. The frame 10E shown on FIG. 1E is adapted for receiving a symbol which is shaped as a ‘4’ and includes a left spacing guide and a right spacing guide both comprising a bump, but the bumps of the left spacing guide and the right spacing guide are not symmetrical either length wise or width wise. The frame 10F shown on FIG. 1F is adapted for receiving a symbol which is shaped as a ‘5’ and includes a left spacing guide 18 which does not include a bump or a recess, while the right spacing guide 18 comprises a recess near the bottom hand right corner of the frame 10F. The frame 10G of FIG. 1G is adapted for receiving a symbol which is shaped as a ‘6’ and includes a left spacing guide comprising two bumps of different sizes both lengthwise and widthwise, and a right spacing guide comprising a bump which is not symmetrical with either of the bumps on the left spacing guide. The frame 10H on FIG. 1H is adapted for receiving a symbol shaped as a ‘7’ and comprises a recess on the left spacing guide and three different recesses on the right spacing guide. The three recesses on the right spacing guide of the frame 10H differ in length, width, and shape. The frame 10I shown on FIG. 11 is adapted for receiving a symbol which is shaped as an ‘8’ and includes a left spacing guide 18 which does not include a bump or a recess, while the right spacing guide 18 includes a recess near the bottom hand right corner of the frame 10I. The frame 10J shown on FIG. 1J is adapted for receiving a symbol shaped as a ‘9’ and has a left spacing guide that does not comprise any bump nor recess, while the right spacing guide of the frame 10J comprises two bumps and a recess, and the two bumps are of different sizes and width.

Although not shown on the present Figures, the present tool could alternatively be used for positioning attachments of the symbols. In this alternative, it is the attachments of the symbols which must be positioned and/or affixed to the surface, the frames 10 may illustrate a symbol and define one or multiple positioning apertures 12 corresponding to where attachments for the corresponding symbol must be drilled in the surface. In this embodiment, the symbol to be installed is illustrated on the border 14 instead of being defined as an aperture for receiving the symbol. The combination of spacing guides 18 of contiguous frames creates a predefined spacing between the symbols illustrated therein.

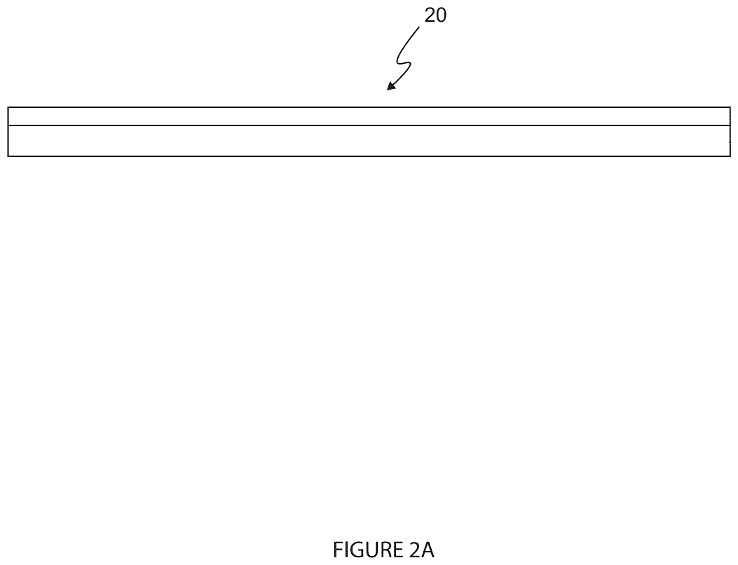

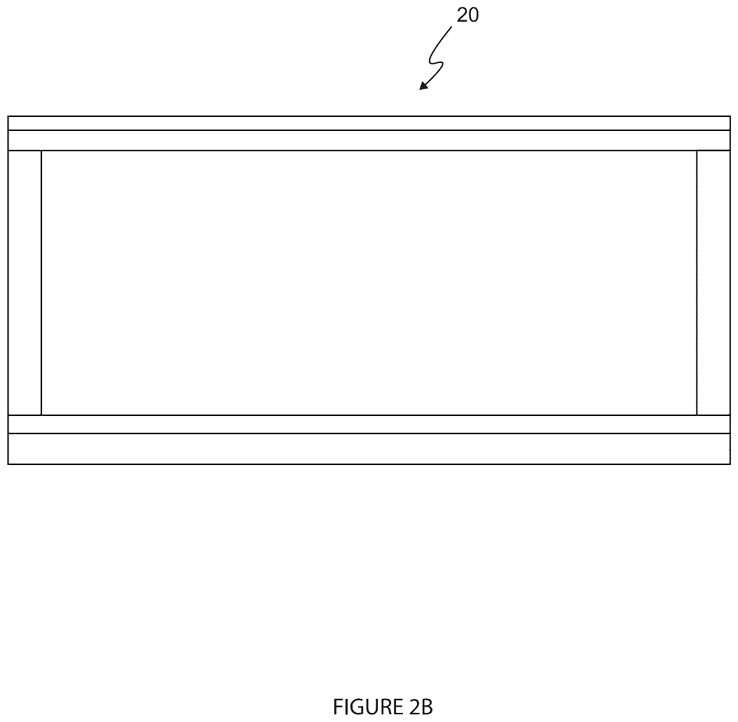

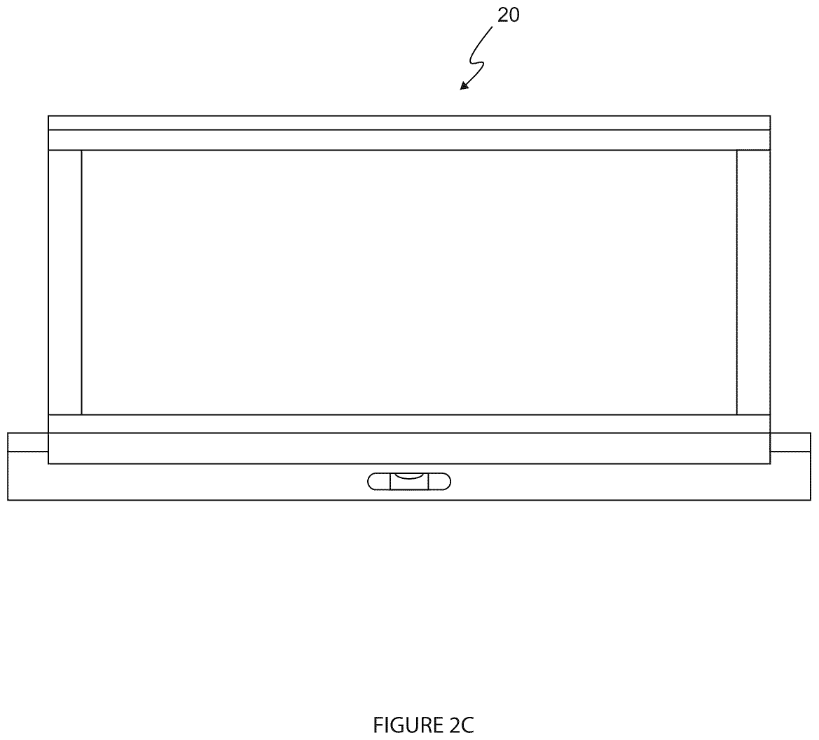

Reference is now concurrently made to FIGS. 2A-2C. More particularly, FIG. 2A depicts a supporting structure 20 with only one superior member for receiving a plurality of the frames 10. The securing guides 18 of the frames may be positioned into the superior member held therein by any type of securing, gripping, squeezing, attaching, or holding known in the art. FIG. 2B depicts a supporting structure 20 with only one inferior member for receiving the plurality of frames 10. Finally, FIG. 2C depicts a supporting structure 20 with a superior member, an inferior member and two side members. The plurality of frames 10 may be for example slidably inserted between the superior and inferior members of the supporting structure 20.

FIG. 2C further shows the supporting structure 20 provided with a leveling indicator (in the present instance a bubble type level) to ensure proper leveling of the supporting structure 20. The supporting structure 20 may further comprise a damage free adhesive strip (not shown) to temporarily affix the supporting structure 20 on the surface on which the symbols are to be installed. The supporting structure 20 may further comprise a centering indicator (not show) for centering the frames in the supporting structure 20.

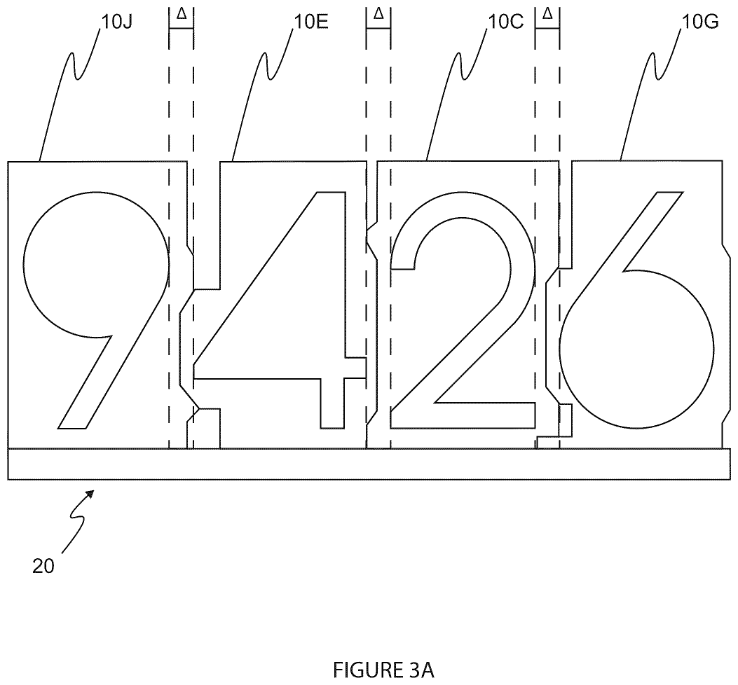

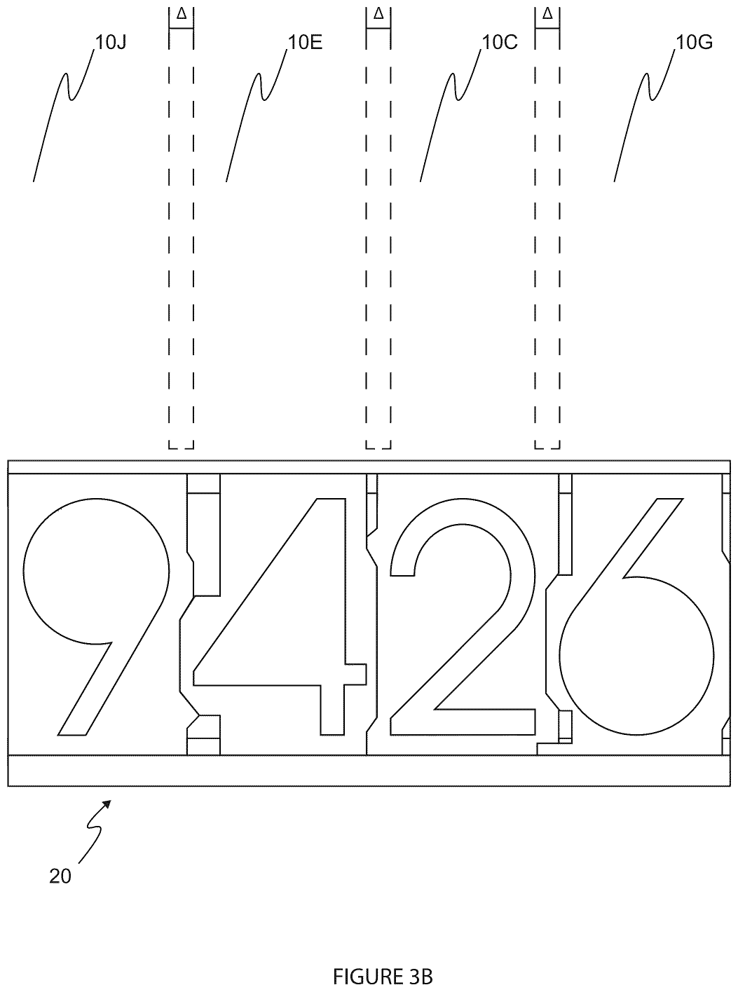

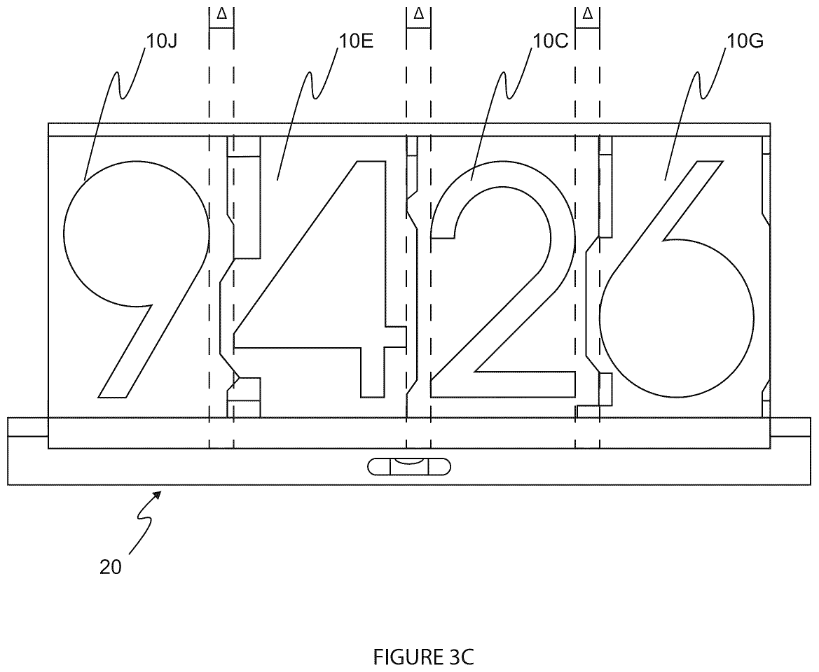

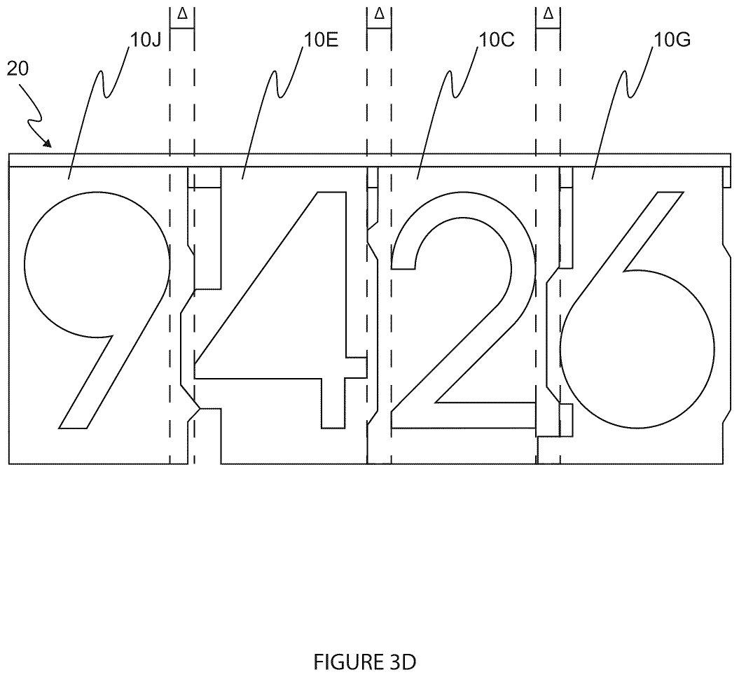

FIG. 3A-3C depict three examples of the supporting structure 20 with a combination of frames to illustrate the use of the present tool. The tool shown on FIG. 3A depicts the supporting structure 20 shown on FIG. 2A with the frames 10J, 10E, 10C and 10G secured therein for positioning symbols 9426. The tool shown on FIG. 3B depicts the supporting structure 20 shown on FIG. 2B, while the tool shown on FIG. 3C depicts the supporting structure 20 shown on FIG. 2C.

FIGS. 3A-3C show the combination of three different supporting structure 20 with one exemplary combination of the frames 10. As illustrated on FIGS. 3A-3C, the spacing guides 18 of the frames 10 are adapted for being placed contiguously, i.e., at least a portion of the spacing guide 18 of one frame 10 is in contact with the spacing guide 18 of the next frame. The spacing guides 18 of each frame 10 are adapted to create a predefined spacing Δ between the symbols received in contiguous frames 10. So the frame 10J when placed contiguously with frame 10E creates the spacing Δ between the symbols 9 and 4. The frame 10E when placed contiguously to the frame 10C creates the predefined spacing Δ between the symbols 4 and 2, etc. The predefined spacing Δ between contiguous symbols is made possible by providing the spacing guides 18 on the frames, where each spacing guide differs from another spacing guide, and the shape and size of each spacing guide depends on the symbol to be received therein, and on the particularities of the spacing guides of the other symbols. For example, the frame 10J for symbol 9 includes a linear spacing guide 18 on the left side, while the spacing guide 18 on the right side of the frame 10J includes two bumps and one recesses between the bumps to create the predefined spacing. Although not shown, one skilled in the art would visually appreciate that when putting contiguously the frames 10J and 10G to position a sequence of symbols 96, the bump defined on the spacing guide 18 of the frame 10G would not fit within the recess of the spacing guide 18 on the right side of the frame 10J. The bump defined on the spacing guide 18 of the frame 10G would touch the right spacing guide 18 of the frame 10J without being embedded therein as shown on FIG. 3A. However, the contiguity of the frames 10J and 10G would create the predefined spacing Δ between the symbols 9 and 6.

As can be appreciated, it is the combination of the spacing guides 18 of the contiguous frames that create the predefined spacing Δ between the symbols to be installed or positioned. The predefined spacing Δ is directly dependent of the at least one bump and/or recess present on at least one spacing guide 18 of each frame. Without at least one bump and/or recess on at least one spacing guide 18 of each frame, it would not be possible to achieve a consistent predefined spacing Δ when installing or positioning the symbols.

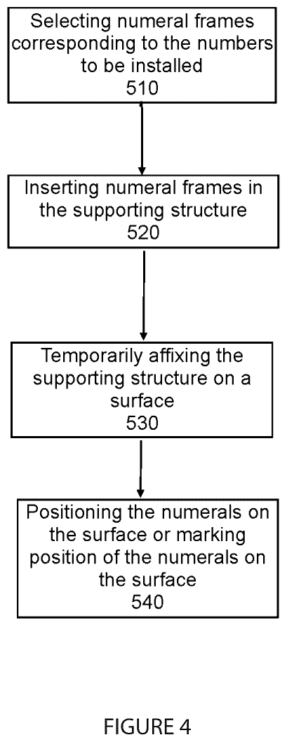

Reference is now made concurrently to FIGS. 1A-1J, 2A-2C, 3A-3C and FIG. 4, where FIG. 4 is a flowchart of a method for installing symbols on a surface. The method stars with selecting (510) at least two frames corresponding to the symbols to be installed on the surface. The method continues with inserting (520) the selected frames, and more particularly the guides of the selected frames in the supporting structure. The frames are inserted in the supporting structure and the spacing guides of contiguous frames are put in contact. The method may include affixing the contacting frames inserted into the supporting structure. The method continues with temporarily affixing (530) the supporting structure on the surface (for example a wall) where the symbols to which the frames correspond are to be installed. The method continues with positioning (540) the symbols by inserting the symbols in the apertures of the frames or marking on the surface the apertures.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A tool for positioning a plurality of symbols to be installed on a surface, the tool comprising:
a plurality of frames, each frame defining an aperture corresponding to one of the symbols to be positioned, each frame providing a border around said aperture, said border defining a securing guide and two opposite spacing guides where each spacing guide is adjacent an opposite end of the securing guide, at least one spacing guide of each frame comprises at least one of a bump and/or a recess;
a supporting structure for receiving the securing guide of the plurality of frames; and
wherein the combination of the spacing guides of contiguous frames creates a predefined spacing between the symbols received therein.

2. The tool of claim 1, wherein the spacing guides of some of the plurality of frames embed a portion of a contiguous spacing guide.

3. The tool of claim 1, wherein the supporting structure is one of: a sliding structure in which the plurality of frames is slidably inserted; a grasping structure which holds therein the securing guide of frames; or a receiving structure for receiving the plurality of frames.

4. The tool of claim 1, wherein:
the border of the frames defined opposite parallel securing guides; and
the supporting structure defines opposing slides for slidably receiving therein the securing guides of the at least two frames.

5. The tool of claim 1, wherein the opposite spacing guides vary in size around the aperture.

6. The tool of claim 1, wherein the supporting structure further comprises a leveling indicator.

7. The tool of claim 1, wherein the supporting structure further comprises a damage free adhesive to temporarily affix the supporting structure on a wall where the at least two symbols are to be installed.

8. The tool of claim 1, wherein the supporting structure further comprises a centering indicator for centering the at least two symbols in the supporting structure.

9. The tool of claim 1, wherein the supporting structure is slidably extendable.

10. A method for positioning a plurality of symbols to be installed on a surface, the method comprising:
selecting at least two frames, each frame defining an aperture corresponding to one of the symbols to be installed on the surface, each frame providing a border around said aperture, said border defining at least one securing guide and two opposite spacing guides, each spacing guide being adjacent an opposite end of the securing guide, at least one spacing guide of each frame comprises at least one of a bump and/or a recess;
inserting the securing guides of the at least two frames in a supporting structure and ensuring order and contact of the spacing guides of sequential frames, the combination of spacing guides of contiguous frames creates a predefined spacing between the symbols received therein;
temporarily affixing the supporting structure on a wall where the symbols are to be installed; and
positioning the symbols to be installed through the apertures of the frames.

11. A method for positioning symbols to be installed on a surface, the method comprising:
selecting at least two frames, each frame defining at least one installation aperture corresponding to one of the symbols to be installed, each frame providing a border around said at least one installation aperture, said border defining a securing guide and two opposite spacing guides where each spacing guide is adjacent to an opposite end of the spacing guide, at least one spacing guide of each frame comprises at least one of a bump and/or a recess;
inserting the securing guide of the at least two frames in a supporting structure and ensuring order of the at least two frames and contact of the spacing guides of sequential frames, the combination of spacing guides of contiguous frames creates a predefined spacing between the symbols when installed;
temporarily affixing the supporting structure on the surface where the symbols are to be installed; and
marking on the surface position of the at least one installation aperture for each one of the at least two frames.

12. A frame for positioning a symbol to be installed on a surface, the frame comprising:
a border defining an aperture corresponding to the symbol to be positioned, the border defining two opposite spacing guides, at least one spacing guide comprises at least one of: a bump and/or a recess;
wherein the combination of the spacing guide with a spacing guide of another contiguous frame creates a predefined spacing between the symbol received therein and a contiguous symbol received in the contiguous frame.
